(19) United States
(12) Patent Application Publication
(10) Pub. No.: US 2009/0030791 A1
(43) Pub. Date: Jan. 29, 2009

(54) METHOD FOR IDENTIFYING A SPORT FIELD BOUNDARY OR FEATURE AND REALIZING REVENUE THEREFROM

(76) Inventors: Prasanna Chitturi, Pleasanton, CA (US); Anand Kasukurthi, Portland, OR (US)

Correspondence Address: NIXON PEABODY, LLP, 401 9TH STREET, NW, SUITE 900, WASHINGTON, DC, 20004-2128, US

(21) Appl. No.: 12/160,776

(22) PCT Filed: May 2, 2006
(86) PCT No.: PCT/US2006/016877

§ 371 Date: Jul. 11, 2008

(51) Int. Cl. G06Q 30/00

(52) U.S. Cl. 705/14

(57) ABSTRACT

Sport field's boundaries are divided into boundary sections according to their major function. The right to name each boundary is then sold to realize further revenue. Additionally, in exchange for the right to broadcast from the sport arena, the sport announcers are required to refer to the boundaries by the names chosen by the entities that purchased the right to name the boundaries. In this manner, the entities naming the boundaries may reach audience beyond the sport arena.

### BACKGROUND

1. Field of the Invention

The subject invention relates to the field of sport activities requiring a field or a course having marked boundaries or distinct features. The subject invention also relates to methods for raising revenue from advertising during a sport activity.

2. Description of Related Arts Various sport activities take place in a field or a course. Examples are basketball, football, soccer, tennis, golf, cricket, etc. Such fields or courses are normally rectangular, although other shapes are used, such as the diamond field of a baseball game, or a circular or oval shaped field in cricket. In many such sport fields, certain rules are applied to the boundaries or certain features. For example, in many ball games, when the ball passes a boundary, the ball changes to the other team. It should be noted that in the context of this specification, the term boundary includes reference to interior boundaries existing within the fields itself. For example, a tennis court has external boundaries that delineate the boundaries of the total playing area, and also has a net that is an interior, center boundary that delineates the boundary between the playing areas of both players. Heretofore, there is no method to consistently refer to each boundary section and precisely convey relevant information. For example, when a ball leaves a side boundary of a playing field, a game announcer may indicate that the ball left the side boundary, but it is unclear which side. That is, for one team it would be the right side, while for the other it would be the left side. Similarly, in a tennis match, when the ball hits the net, in the prior art there is no method of conveying which side of the net the ball hit, other than by stating which player hit the ball.

On a related matter, it is conventional to realize revenue during a sporting event by advertising. For example, various advertisement signs are placed in various locations inside and outside the field. Many are placed as close to the field boundary as possible, with the hope that a TV or a still camera would catch the sign as the photographer photographs a player or the ball. Another method is to have event or field sponsorship. For example, stadiums may be sponsored by a company and be called by the company's name, such as the MCI Arena, etc. While stadium or event sponsorship reaches audience beyond the event by the sport announcers referring to the field or the event by the sponsor's company name, signs on the field may or may not reach audience beyond the field, depending on whether the sign was placed at a location that was being photographed at that game and the photograph being broadcasted or printed in a newspaper or magazine. However, there is no way to guarantee that the sign advertisement would reach audience beyond the particular sport event that it was placed.

Therefore, there is a need in the prior art to have a method for consistently and accurately referring to sections of sport field boundaries and relevant features. Similarly, there is a need to enable sport activity sponsorship that would consistently reach audience beyond the field where the sport activity takes place.

In the description herein, the terms field, course, arena, etc. are used interchangeably and a reference to one term may constitute a reference to any and all of the other terms.

### SUMMARY

The invention was made in view of the deficiencies of the prior art and provides methods and processes for overcoming these deficiencies. According to embodiments and aspects of the subject invention, methods are provided that enable consistent reference to a field boundary or feature, while also enabling the realization of revenue from the boundary or feature and enable advertising that would consistently reach audience beyond the sport arena where the event takes place.

According to one aspect of the invention, the sport field's boundaries are divided into boundary sections according to their major function, e.g., in a rectangle field the division would be two end boundaries and two side boundaries. A centerline may be divided according to the direction of motion of the ball, i.e., from left to right or from right to left. Other divisions can be made according to the particular field design, game rules, and other circumstances. For example, each side boundary can further be divided into two sections, each designating one side of one team's field area.

The right to name each boundary is then sold or leased to realize further revenue. Additionally, in exchange for the right to broadcast from the event, the sport announcers can be required to refer to the boundaries by the name chosen by the entity that purchased the right to name the boundary, i.e., the sponsor. In this manner, the entity naming the boundary may reach audience beyond the sport arena.

According to another aspect of the invention, the right to name the boundary also includes the imposition of the name on the boundary. The imposition may be implemented by, for example, physically printing the brand name over the boundary line; physically painting the brand name in close proximity to the boundary line; digitally imposing the brand name over the imagery, etc. When a net is used as the centerline, the brand imposition may be implemented by having one brand on one side of the net, while another brand on the other side of the net.

### BRIEF DESCRIPTION OF THE DRAWINGS

Other aspects and features of the invention would be apparent from the detailed description, which is made with reference to the following drawings. It should be appreciated that the detailed description and the drawings provide various non-limiting examples of various embodiments of the invention, which is defined by the appended claims.

FIG. 1 is a schematic of an embodiment of the invention applied to a generic rectangular playing field.

FIG. 2 is a schematic of another embodiment of the invention applied to a generic rectangular playing field.

FIG. 3 depicts yet another embodiment of the invention, as applied to a generic rectangular playing field.

FIG. 4 depicts an example wherein the game field includes a net, such as tennis, volleyball, ping-pong, etc.

FIG. 5 depicts yet another embodiment of the invention applied to a conventional rectangle sport field.

FIG. 6 depicts another embodiment of the invention to illustrate how borders and features may be sponsored according to the invention.

FIG. 7 is a diagram for further illustrating the sponsorship of boarders and features.

FIG. 8 depicts an embodiment wherein the sponsorship is predominantly of features, rather than boundaries.

FIG. 9 illustrates an example of cricket grounds having various identifiable boundaries and features that may be sponsored according to embodiments of the invention.

FIG. 10 illustrates an example of boxing ring having various identifiable boundaries and features that may be sponsored according to embodiments of the invention.

### DETAILED DESCRIPTION

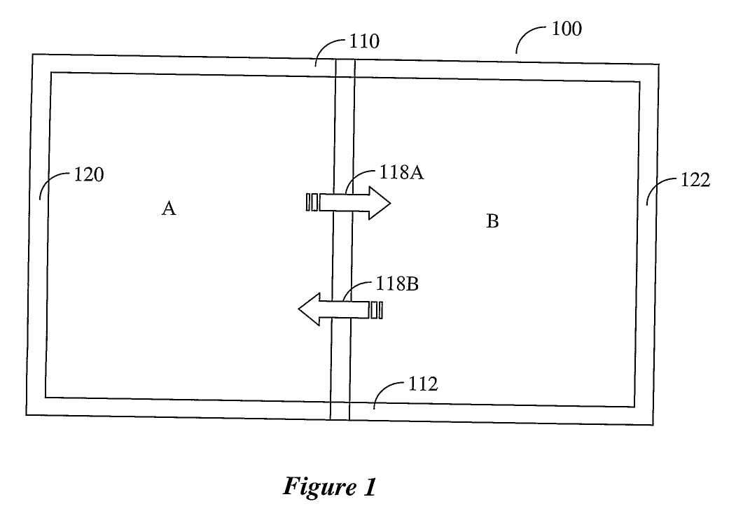

FIG. 1 depicts a generic rectangular playing field 100. The field 100 has various features such as an external boundary that delineates the ends of the playing area, and an interior boundary that delineates the two sides, A and B, of the playing fields. The external boundary is divided into boundary sections. For example, two end boundaries 120 and 122, and two side boundaries, 110 and 112. Further, the interior boundary, which in this example is a centerline 118, is divided according to the direction of play, e.g. 118A when the play is from the A side to the B side, and 118B when the play is from the B side to the A side of the field. In order to consistently and precisely refer to these boundaries, each boundary is given a name. In one example, the end boundaries, 120, 122, are named according to the team playing on the corresponding side, for example, Team A end boundary for end boundary 120. However, the right to name the side boundaries, 110,112, and the center boundary, 118, are sold off or leased to realize revenue. Purchasers of the naming rights can use the right for advertising purposes or other novelty purposes, such as using their own name, using a loved-one's name, etc. Of course, the right to name the end boundaries, 120, 122, can also be sold or leased.

The advantage of this method over the prior art can be understood from the following. First, in the prior art, when a ball leaves the field, say from boundary 110, it is difficult for announcers to consistently and precisely describe the boundary that the ball crossed. That is, for the team playing in side A, boundary 110 is the left boundary, while for the team playing in side B, boundary 110 is the right boundary. The matter becomes even more confusing when the teams switch sides on the field after half time, etc. Consequently, announcers generally only indicate that the ball is out of bounds, without any further indication.

However, using the embodiment of FIG. 1, announcers can consistently and precisely refer to the boundary. For example, assuming that the right to name the boundary 110 was paid for by Mercedes and was named Mercedes, while boundary 112 was named Dell. Under such circumstances, when the ball leaves boundary 110, it can be simply said that the ball is out of the Mercedes bounds or crossed the Mercedes line. Similar circumstances arise with respect to the interior boundary. For example, assuming that the field shown in FIG. 1 is a tennis court, and that side 118A was named Mercedes and side 118B was named Dell, then when the ball hit the 118A net, i.e., while moving from side A to side B, it can be stated that the ball hit the Mercedes net; while when the ball hit the net while moving from side B to side A, it can be stated that the ball hit the Dell net. In this manner consistency and accuracy is achieved in describing the situation. Additionally, while describing such situations in the news media, audience beyond the arena is reached, so that the entity that purchased the naming right achieves advertising beyond the arena. Moreover, such advertising messages can be made during precious cliffhanger moments of the game and are also immune to channel surfing by distant viewers through television or the internet.

In the present description the term feature is understood to include the term boundary; however, for clarity of explanation the term boundary is specifically used when referring to a boundary, while the term feature is specifically used to refer to a feature other than the boundary. It should be understood; however, that in the description and the appended claims the term feature generally encompasses and includes the term boundary. That is, boundaries are taken to be a specific case of features.

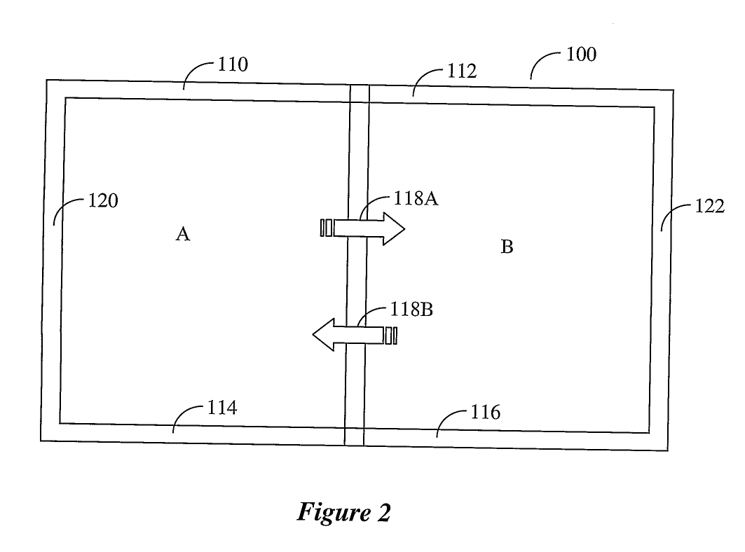

FIG. 2 is a schematic of another embodiment of the invention applied to a generic rectangular playing field. In this embodiment, the side boundaries are further divided into two sections each, i.e., one side is divided into boundaries 110 and 112, while the other into boundaries 114 and 116. According to this embodiment, the right to name each section can be paid for by the same or different entity. For example, if each section is paid for by a different entity, then calling each section would be named by simply calling the name chosen by the sponsor. On the other hand, if one entity paid for two or more sections, the distinction between the sections can be made using a variety of methods, such as, for example, adding a modifier to the name. Using the above Mercedes and Dell example, line 110 can be called the Red Mercedes line, while line 112 can be named the Blue Mercedes line. To further illustrate, assuming that lines 114 and 116 were paid for by Ford, then line 114 can be called the Ford Taurus line, while line 116 can be called the Ford Explorer line, thereby providing enhanced advertising.

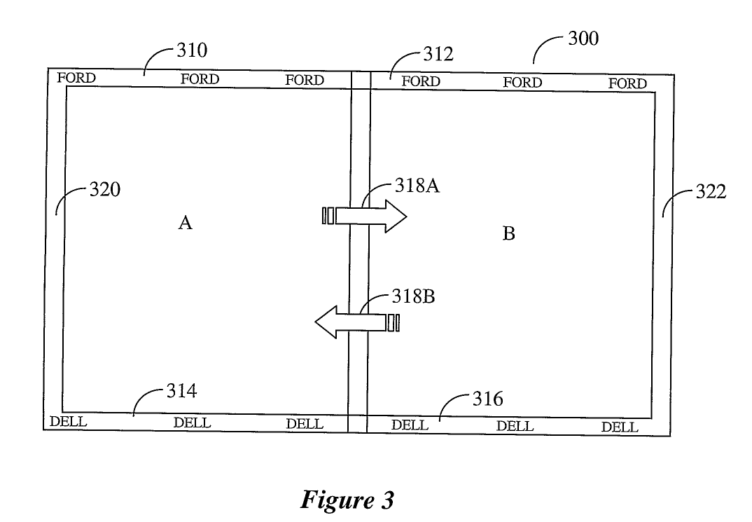

FIG. 3 depicts yet another embodiment of the invention, as applied to a generic rectangular playing field. In this embodiment, in addition to having the naming rights, the sponsor also has the right to paint the boundary. In the example of FIG. 3, the sponsor's name is painted on top of the boundary line. Additionally, the color of the boundary can be selected by the sponsor. For example, Ford consistently uses the color blue in its marketing material and corporate identity. Therefore, in this example boundaries 310 and 312 may be painted blue. In the context of this embodiment, it should be appreciated that the sponsor's name or logo can be physically painted on the boundary. Alternatively, the name or logo can be added digitally during broadcasting of the sponsored event. Additionally, in any of the embodiments described herein, the sponsorship can be provided for a definite time period, e.g., for one game, for one season, etc.

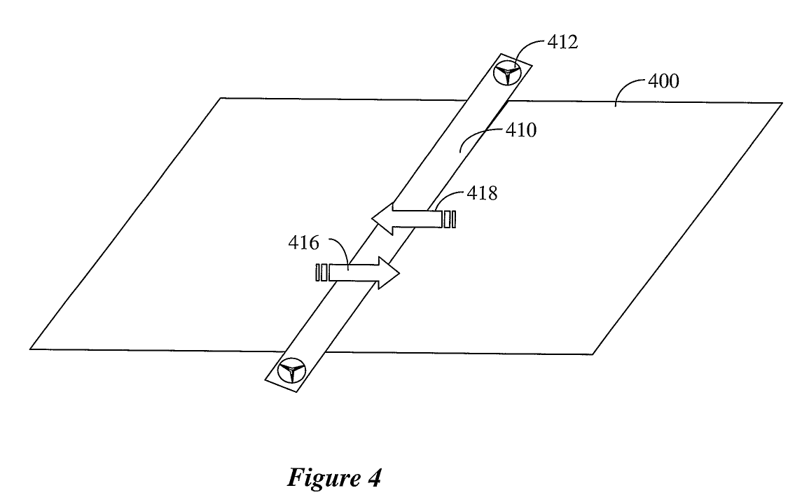

FIG. 4 depicts an example wherein the game field includes a net, such as tennis, volleyball, ping-pong, etc. Generally, the net 410 divides the field 400 into two sections, wherein a ball is moved in directions 416 and 418. Consequently, the net 410 functions as a boundary, which, in this example, is defined according to the movement of the ball. That is, when the ball crosses the boundary in direction 416 the boundary can be referred to using one name, while when it is moving in the other direction, 418, the net can be named according to another name. The name is then made available for sponsorship. Moreover, in order to assist in the naming, and to provide further advertising exposure to the sponsor, the sponsor's name or logo can be printed on the side indicating the sponsorship side. In the example of FIG. 4, the boundary associated with direction 418 is sponsored by Mercedes and, therefore, the Mercedes logo is shown on that side. The reverse side can be sponsored by another company and its name or logo shown on the other side of the net. Therefore, in this example, when the ball hit the net while moving in direction 418, it can be announced that the ball hit the Mercedes net. In this manner, it is clear to the audience that the ball hit the net while moving in direction 418. Additionally, the sponsorship receives further recognition in verbal form and broadcasting format.

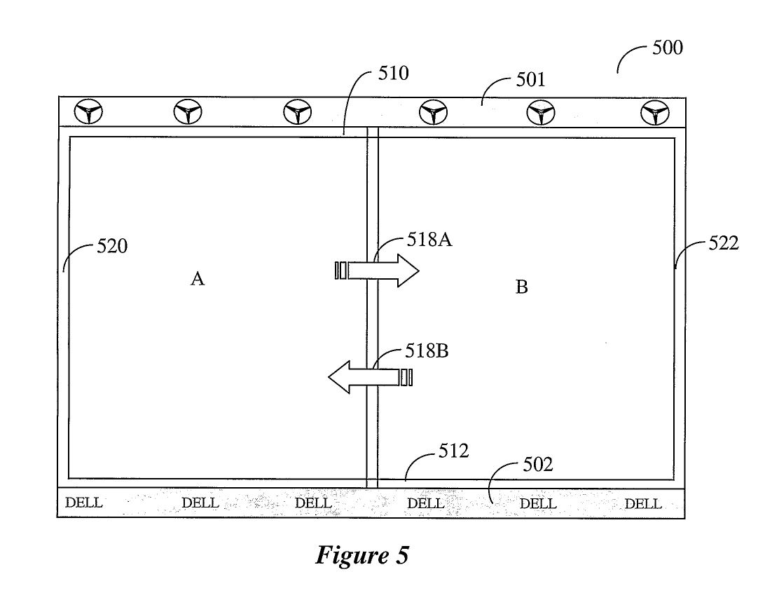

FIG. 5 depicts yet another embodiment of the invention applied to a conventional rectangle sport field 500. As is well known, normally the lines defining the field boundaries, e.g., 510, 512, 520, 522, are painted white and are relatively narrow. Consequently, it is difficult to fit a brand name or logo onto the line at a size that would be readable for the audience. Also, if the line is painted other than white, it may confuse the players. Therefore, according to the embodiment of FIG. 5, the lines delineating the boundary, i.e., 510, 512, 520, 522, are painted white and are of standard width. However, an additional sponsorship section is defined adjacent to a line to be sponsored. For example, sponsorship area 501 is defined adjacent to sideline 510, while sponsorship area 502 is defined adjacent sideline 512. According to this embodiment, when a sponsorship to name a line is awarded, it also includes the right to the design of the adjacent sponsorship area.

With respect to digital imposition of text or graphics over the broadcast on the field, any conventional method can be used to implement the methods and processes of this invention. For example, Apple's Final Cut Pro software can be used in conjunction with AJA's Kona card connected to an Apple G5 computer to edit the broadcast of the sporting event in real time. Additionally, any layering software can be used, e.g., Shake from Apple, to add a layer having the sponsorship logo, name, etc. For enhanced digital imaging capability, chroma key (blue screen) technology can be used by physically painting the areas on the field to be edited using a blue color. For example, in FIG. 5, areas 501 and 502 can be physically painted blue on the field, and then edited during the broadcast to include the sponsorship.

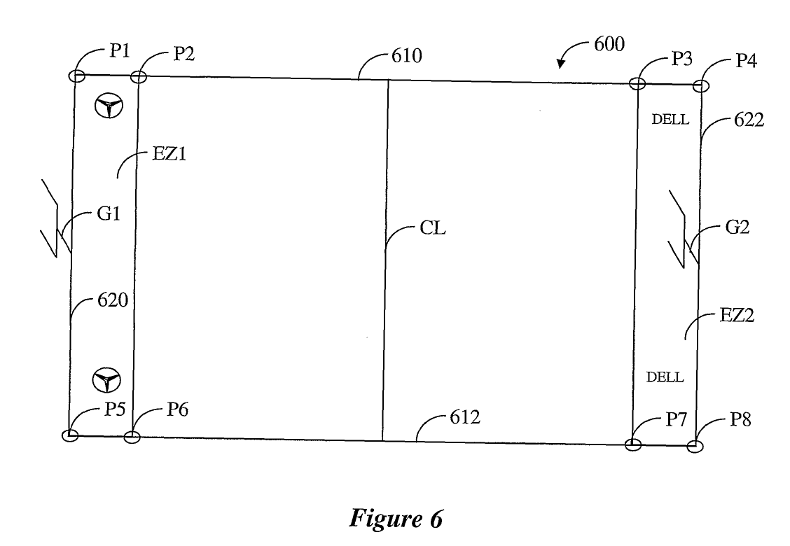

FIG. 6 depicts another embodiment of the invention to illustrate how borders and features may be sponsored according to the invention. Notably, FIG. 6 illustrates a football field 600 having side boundaries 610, 612, end boundaries 620, 622, and centerline CL. These boundaries can be named and sponsored as explained with respect to the other embodiments herein. Additionally, football field 600 includes various features that may also be named and sponsored. For example, football field 600 has two endzones EZ1, EZ2, both of which can be named and sponsored. As with other embodiments described herein, the sponsorship indication may be embossed on the field by physically painting it or digitally editing images of the field. In the example of FIG. 6 this is illustrated by Mercedes and DELL logo being painted on the field. Other features may also be sponsored, such as the goal posts and the pylons P1-P8. As can be understood, the pylons can be sponsored individually or in groups.

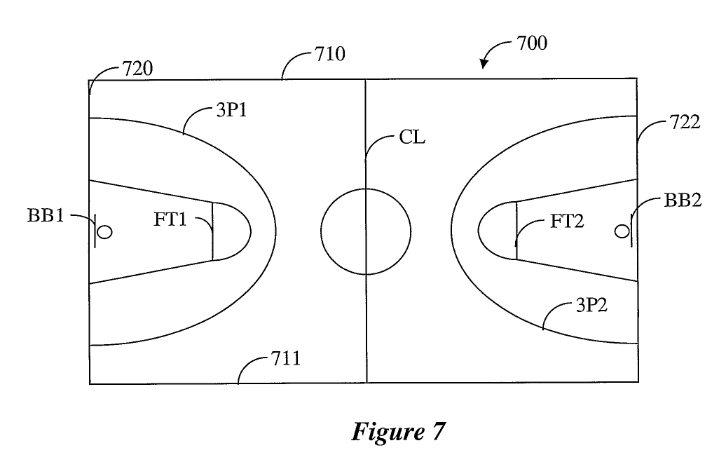

FIG. 7 is a diagram for further illustrating the sponsorship of boarders and features. FIG. 7 is a diagram of a basketball field, in which the boundaries 710, 712, 720, 722, and CL may be sponsored. Additionally, other features may be sponsored, such as the free-through lines, FT1, FT2, the 3-point lines, 3P1, 3P2, backboard BB1, BB2, etc.

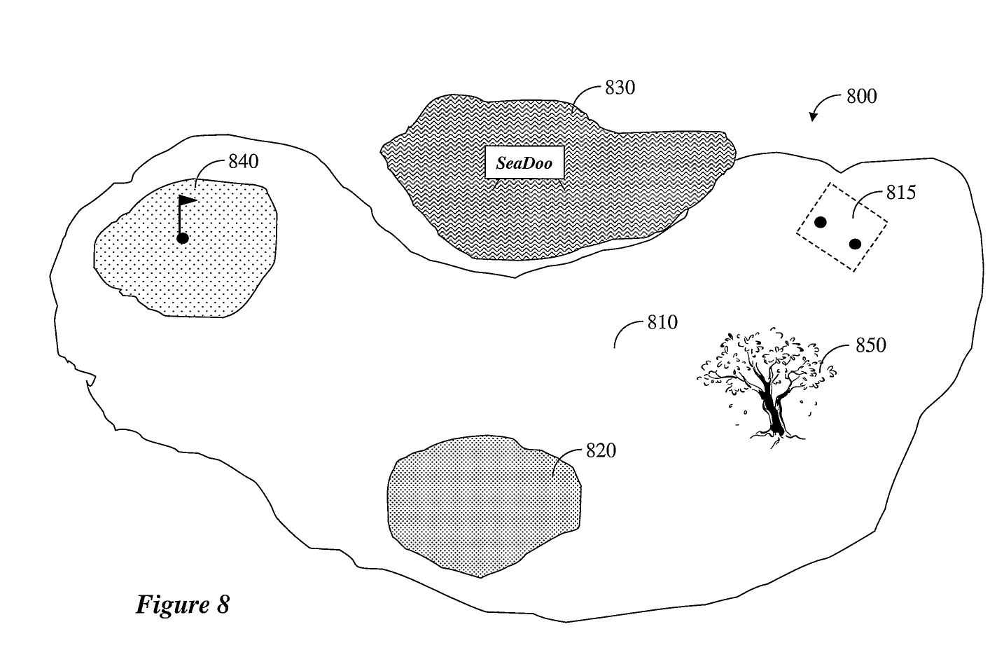

FIG. 8 depicts an embodiment wherein the sponsorship is predominantly of features, rather than boundaries. FIG. 8 is an illustration of one “hole” of a golf course. That is, in the illustration only a section 800 of the entire golf course is illustrated, showing an exemplary layout of a section from the tee box 815 to the green 840 and hole cup. As can be understood, in such a golf course, no boundaries are provided in the general sense of the term as illustrated with respect to the other sport fields discussed above. However, the golf course includes many features that may be sponsored in accordance with embodiments of the invention. For example, the fairway 810, tee box 815, sand trap 820, water hazard 830, green 840, are all features that may be sponsored. The sponsorship may be for one section, such as section 800, or for the entire course (9 or 18 holes, etc.). The sponsorship may be accompanied by signage, as exemplified by the SeaDoo sign over the water hazard 830.

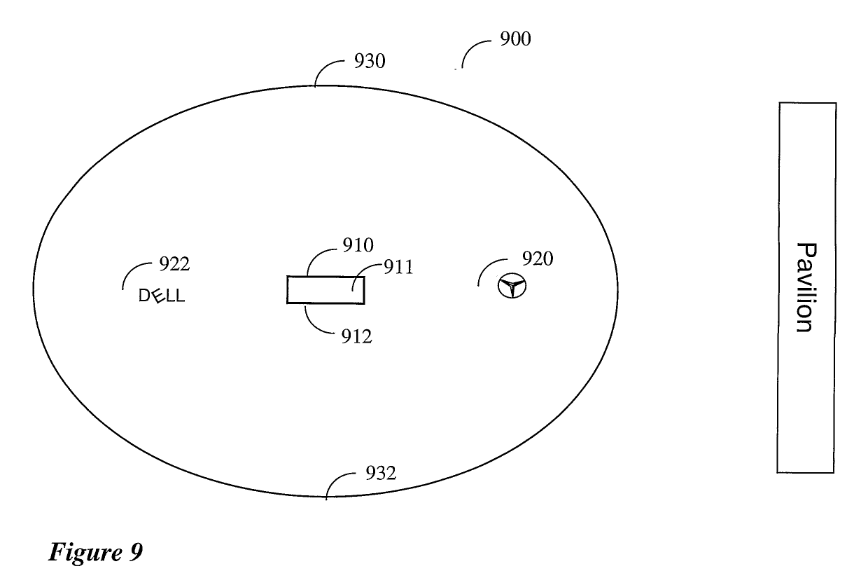

FIG. 9 illustrates an example of cricket grounds having various identifiable features that may be sponsored according to embodiments of the invention. FIG. 9 is rather self-explanatory, depicting the various features that are generally identifiable on cricket grounds. Each and any of these features may be sponsored according to the embodiments of the invention described herein. For example, as the ball is bowled from the pavilion side, the action is always referred to as bowling from the “pavilion side” and if from the opposite side, a physical feature outside the stadium is used as a reference, for example “church side” if indeed a church stood on that side outside the stadium. Sections 920 and 930 can now be referred to instead by the name of the sponsor. The pitch 911 is a central feature of the game and can be sponsored as can either side of the pitch, 910 and 912. It is important to be able to say which side of the pitch has a unique behavior as the match progresses. For example the west end of the pitch can have a soft spot on the on-side and it might get worse as the game progresses. The sponsors' name(s) can be used to identify the precise location irrespective of on which side the batsman is, or whether it is a right-handed batsman or a left-handed batsman. Furthermore, sections of the boundary 930 and 932 can be identified for sponsorship. In the present art, 930 and 932 are identified by a combination of two factors: side of the pitch where the batsman is taking strike and on whether the batsman is a right-handed or a left-handed batsman. With the present invention, that ambiguity can be removed. If for instance side 930 is a faster outfield, it can be identified as such very easily by using the name of sponsor. The sponsor's name can be chalked on the field and/or when ropes are used can be painted on the ropes.

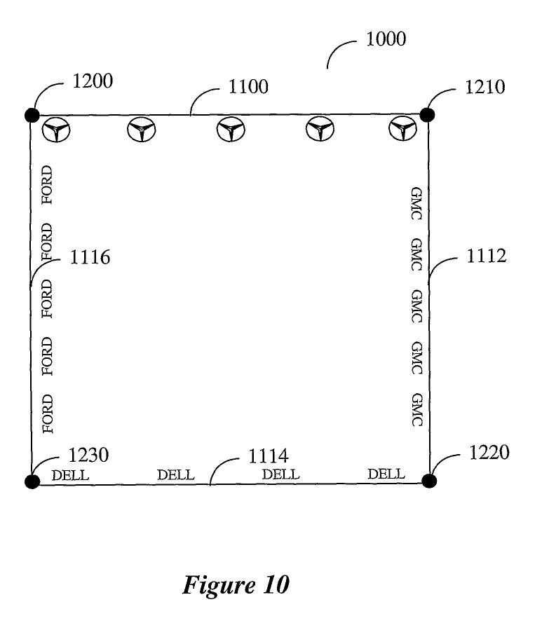

FIG. 10 shows how the present invention can be applied to the boxing ring 1000. Each of the 4 sides 1100, 1112, 1114, and 1116 can be clearly referred to and its sponsor identified in the referral. Providing sponsorship rights over the sides can help in announcing the match in a more visual and vivid manner, as it will help the listener identify and visualize each side of the boxing ring. Similarly, providing sponsorship of the corner posts 1200, 1210, 1220, 1230 can help in visualizing the boxing ring. In order to help in identifying the sponsorship of the ring's sides, according to one embodiment the sponsor's name is painted on the stage below the respective ropes, as illustrated in FIG. 10.

Thus, while only certain embodiments of the invention have been specifically described herein, it will be apparent that numerous modifications may be made thereto without departing from the spirit and scope of the invention. Further, certain terms have been used interchangeably merely to enhance the readability of the specification and claims. It should be noted that this is not intended to lessen the generality of the terms used and they should not be construed to restrict the scope of the claims to the embodiments described therein. For example, as used herein and in the appended claims the term broadcast is meant to include broadcast in any format, such as radio broadcast, television broadcast, Webcast, Podcast, etc.

1. A method for consistently and accurately referring to features of a sport field while raising revenue therefrom, comprising:
defining features, each of said features having a defined physical layout on said field;
selling sponsorship right to at least one of said features, said sponsorship right comprising the right to name at least one of said features;
referring to said feature by a name selected by a purchaser of said sponsorship right.

2. The method of claim 1, wherein said sponsorship right further comprises the right to select the visual appearance of the physical layout of at least one of said features.

3. The method of claim 2, wherein said physical appearance comprises physical painting of the physical layout of one of said feature.

4. The method of claim 2, wherein said physical appearance comprises broadcast representation of the physical layout of one of said feature.

5. The method of claim 4, wherein said broadcast representation comprises digital editing of the physical layout of one of said features.

6. The method of claim 1, further comprising providing game broadcast right to signed broadcasters, said broadcast right comprising announcing each of said features according to the name selected by purchaser of said sponsorship right.

7. The method of claim 1, wherein said field features comprise two end lines, two side lines, and one centerline.

8. The method of claim 7, wherein said centerline is further defined according to direction of movement of a game piece over said centerline.

9. In a sporting event at a sport field defined by boundaries comprising two end lines, two side lines, and one centerline, a method for consistently and accurately referring to the boundaries while raising revenue therefrom, comprising:
defining a physical layout for each of said boundaries;
selling sponsorship right to at least one of said boundaries, said sponsorship right comprising the night to name at least one of said boundaries;
referring to said boundary by a name selected by a purchaser of said sponsorship right.

10. The method of claim 9, further comprising dividing each of said side lines into two sections, each section terminating on one end at one of said end lines, and at the other end at said centerline, and wherein said sponsorship right is further divisible correspondingly to each of said sections.

11. The method of claim 9, wherein said right is valid for a predefined period of time.

12. The method of claim 10, further comprising defining a plurality of sponsorship areas, each sponsorship area being adjacent to a corresponding one of said boundaries.

13. The method of claim 12, further comprising imposing a branding over said sponsorship area.

14. The method of claim 13, wherein said imposing comprises physically painting said sponsorship area.

15. The method of claim 13, wherein said imposing comprises digitally editing the sponsorship area on an image of said sport field.

16. A process for marketing brands during a sporting event, comprising:
designating a sport field having a plurality of features;
assigning a brand name to at least one of said plurality of features, thereby creating branded feature;
providing broadcast rights to broadcast a sporting event in said sport field, said broadcast rights including a requirement to refer to said branded feature by its assigned brand name.

17. The process of claim 16, wherein said assigning comprises providing a sponsorship right to at least one of said plurality of features.

18. The process of claim 16, further comprising imposing the brand name over the branded feature.

19. The process of claim 18, wherein said imposing comprises physically painting the brand name on the branded feature of the sporting field.

20. The process of claim 18, wherein said imposing comprises physically painting the brand name at a close proximity to the branded feature of the sporting field.

21. The process of claim 18, wherein said imposing comprises digitally overlaying the brand name over the branded feature on the photography of the sporting field.

22. The process of claim 18, wherein said imposing comprises digitally overlaying the brand name over the photography of the sporting field at a close proximity to the branded feature.

23. The method of any of claims 16-22, wherein said feature is a boundary of said sporting field.

24. The method of claim 23, wherein said field is rectangular, and said boundary is a side of the rectangular.

25. The method of any of claims 16-22, wherein said field is diamond shape.

26. The method of any of claims 16-22, wherein said field is circular shape.

27. The method of any of claims 16-22, wherein said field is oval shape.
